(19) United States
(12) Patent Application Publication
(10) Pub. No.: US 2025/0296611 A1
(43) Pub. Date: Sep. 25, 2025

(54) CART

(71) Applicant: Vyper Engineering LLC, Green Bay, WI (US)

(72) Inventor: Christopher J. Rusch, Green Bay, WI (US)

(73) Assignee: Vyper Engineering LLC, Green Bay, WI (US)

(21) Appl. No.: 19/084,419

(22) Filed: Mar. 19, 2025

Related U.S. Application Data
(60) Provisional application No. 63/567,836, filed on Mar. 20, 2024.

(51) Int. Cl. B62B 3/00; B62B 3/02

(52) U.S. Cl. CPC B62B 3/005; B62B 3/02; B62B 2301/044

(57) ABSTRACT

A cart includes a frame, a panel, and a plurality of wheels. The frame includes a first post defining a first plurality of slots. The frame further includes a second post defining a second plurality of slots. The frame also includes a first shelf defining a top of the frame and a second shelf defining a bottom of the frame. The first shelf and the second shelf are each coupled to the first post and the second post. The panel including a first prong and a second prong. The first prong of the panel is removably engaged with a first slot of the plurality of first slots. The second prong of the panel is removably engaged with a first slot of the plurality of second slots. The panel defines a third plurality of slots. The plurality of wheels are coupled with the second shelf.

### CROSS-REFERENCE TO RELATED PATENT APPLICATION

This application claims the benefit of and priority to U.S. Provisional Application No. 63/567,836, filed Mar. 20, 2024 and titled “CART,” which is incorporated herein by reference in its entirety and for all purposes.

### TECHNICAL FIELD

The present technology is generally related to storage devices or assemblies. More specifically, the present technology is related to movable storage carts for use in industrial or other settings.

### BACKGROUND

In various settings, a need exists for transporting and/or storing objects. For example, in medical settings, a storage device may be used to store and/or hold medical devices. As another example, in an automotive manufacturing shop, a storage device may be used to store and/or hold automotive tools (e.g., wrenches, welding gloves, etc.). It is therefore beneficial to have a storage device that is adaptable to a wide variety of uses and settings.

### SUMMARY

At least one embodiment relates to a cart. The cart includes a frame, a panel, and a plurality of wheels. The frame includes a first post defining a first plurality of slots. The frame further includes a second post defining a second plurality of slots. The frame also includes a first shelf defining a top of the frame and a second shelf defining a bottom of the frame. The first shelf and the second shelf are each coupled to the first post and the second post. The panel including a first prong and a second prong. The first prong of the panel is removably engaged with a first slot of the plurality of first slots. The second prong of the panel is removably engaged with a first slot of the plurality of second slots. The panel defines a third plurality of slots. The plurality of wheels are coupled with the second shelf.

Another embodiment relates to a cart. The cart includes a frame including a first post defining a first slot and a second post defining a second slot. The first slot includes a bottom edge. The second slot includes a bottom edge. The cart further includes a panel including a first prong, a second prong, and a plurality of slots. The first prong and the second prong each include a first portion and a second portion. The first portion extends from a rear of the panel, the second portion extending from the first portion at angle relative to the first portion to define a notch between the rear of the panel and the second portion. The bottom edge of the first slot is engaged with the notch of the first prong to removably couple the panel with the first post. The bottom edge of the second slot is engaged with the notch of the second prong to removably couple the panel with the second post.

Yet another embodiment relates to a cart. The cart includes a frame. The frame includes a first post, a second post, a first shelf, a second shelf, and a third shelf. The first post defines a first slot having a bottom edge. The second post defines a second slot having a bottom edge. The first shelf defines a top of the frame. The first shelf is coupled to the first post and the second post. The second shelf defines a bottom of the frame. The second shelf is coupled to the first post and the second post. The third shelf is positioned vertically between the first shelf and the second shelf. The third shelf is coupled to the first post and the second post. The cart includes a panel including a first prong, a second prong, and a plurality of slots. The first prong and the second prong of the panel include a first portion and a second portion. The first portion of the first prong and the second prong extends from a rear of the panel. The second portion of the first prong and the second prong extend from the first portion at angle relative to the first portion to define a notch between the rear of the panel and the second portion. The bottom edge of the first slot is engaged with the notch of the first prong to removably couple the panel with the first post. The bottom edge of the second slot is engaged with the notch of the second prong to removably couple the panel with the second post.

This summary is illustrative only and should not be regarded as limiting. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a cart, according to an example embodiment;

FIG. 2 is another perspective view of the cart of FIG. 1, according to an example embodiment;

FIG. 3 is a perspective view of an accessory device of the cart of FIG. 1, according to an example embodiment;

FIG. 4 is a perspective view of a panel of the cart of FIG. 1, according to an example embodiment;

FIG. 5 is a perspective view of the accessory device of FIG. 3 engaged with the panel of FIG. 4, according to an example embodiment;

FIG. 6 is a detail view of a prong of the accessory device of FIG. 3 engaged with the panel of FIG. 4, according to an example embodiment;

FIG. 7 is a perspective view of the accessory device of FIG. 3 and the panel of FIG. 4 engaged with two posts of the cart of FIG. 1, according to an example embodiment;

FIG. 8 is a perspective view of an accessory device for a cart, according to an example embodiment;

FIG. 9 is a perspective view of an accessory device for a cart, according to an example embodiment;

FIG. 10 is a perspective view of an accessory device for a cart, according to an example embodiment;

FIG. 11 is a perspective view of an accessory device for a cart, according to an example embodiment;

FIG. 12 is a perspective view of an accessory device for a cart, according to an example embodiment;

FIG. 13 is a perspective view of an accessory device for a cart, according to an example embodiment;

FIG. 14 is a perspective view of an accessory device for a cart, according to an example embodiment;

FIG. 15 is a perspective view of an accessory device for a cart, according to an example embodiment;

FIG. 16 is a perspective view of an accessory device for a cart, according to an example embodiment;

FIG. 17 is a perspective view of an accessory device for a cart, according to an example embodiment; and

FIG. 18 is a perspective view of a cart with accessories, according to an example embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a cart and related accessories are shown. The cart is a movable cart that is generally suited to be used in industrial settings, such as factories, manufacturing environments, industrial settings. For example, the cart can be used in an automotive repair shop, and one or more users may move the cart to various locations as they perform their work (e.g., from one bay to work on a first vehicle to another bay to work on another vehicle). Because the industrial setting and tasks performed by users working in those settings can vary widely, the cart is configured to be customizable (e.g., modifiable, adaptable, reconfigurable) so as to meet the varied needs of users within the industrial setting. It should be understood, however, that the cart can be used in other settings, such as medical settings, office settings, or educational settings, recreational settings, or other settings. For example, the cart can be used in a medical setting to store various medical tools and supplies.

Advantageously, the cart can include one or more panels that can be removably coupled to and variously positioned on the cart. The cart can further include one or more accessories that can be removably coupled to and variously positioned on the cart. For example, the accessories can be coupled to the one or more panels of the cart. In other configurations, the accessories can be coupled directly to a frame of the cart.

The panels and accessories can be removably coupled to the cart and positioned variously on the cart via an engagement between a prong or projection (e.g., a prong of the panel or the accessory) and an opening (e.g., an opening of the frame or the panel). For example, the frame of the cart can include a plurality of openings that are each configured to receive at least one prong of a panel. The prong of the panel can have a hook-like shape, where the prong includes a first portion extending outward from the panel or accessory and a second portion extending in an at least partially downward direction relative to the panel. The prong can be inserted into the opening such that the frame of the cart is positioned against the first portion of the prong and further positioned between the second portion of the prong and the panel. In this way, the panel can hook onto the frame of the cart to secure the panel to the cart. Advantageously, the panel can be secured to the frame of the cart without the need for fasteners, which further allows for the removal of the panel from the frame. The accessories can include at least one prong to facilitate coupling of the accessory to the frame of the cart in a similar fashion. Further, the panel itself can define at least one opening such that the prong of the accessory can engage with the opening of the panel to couple the accessory to the panel. The frame of the cart can include a plurality of openings so that the prong of the panel can be inserted into at least one desired opening of the frame in order to position the panel in a particular location on the frame according to the user's needs. Likewise, the panel can include a plurality of openings so that the prong of the accessory can be inserted into at least one desired opening of the frame in order to position the accessory in a particular location on the panel according to the user's needs. In this way, the cart is highly customizable and modular. These and other features and benefits are described more fully herein below.

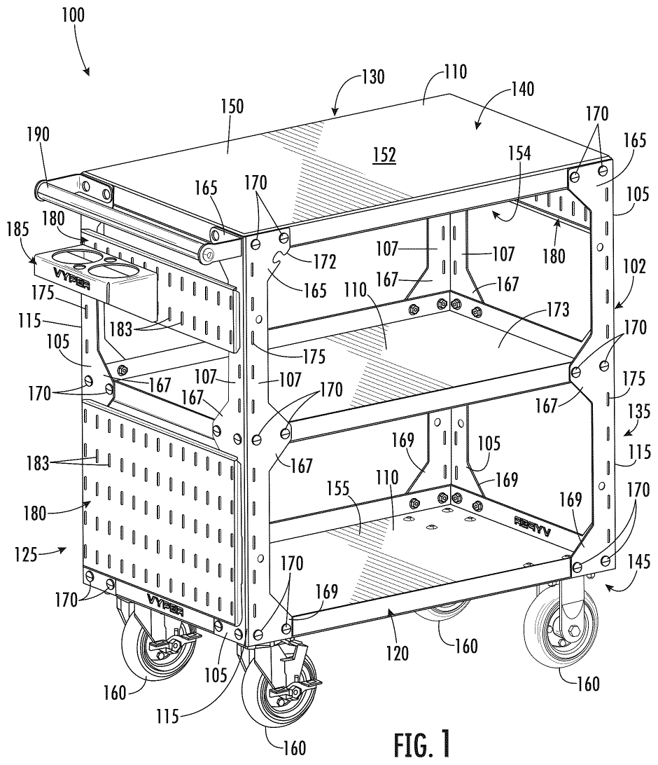

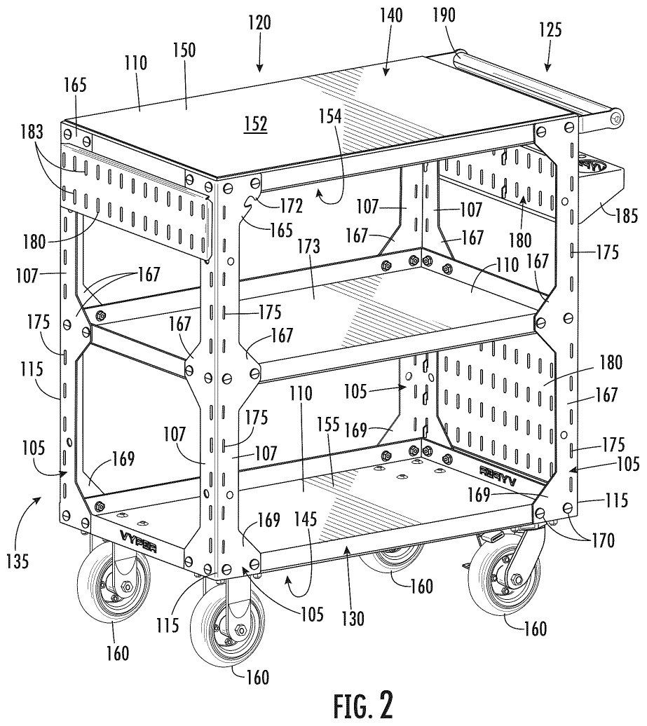

Referring now to FIGS. 1 and 2, a cart 100 is shown, according to an example embodiment. The cart 100 includes a frame 102. The frame 102 may be a unitary (i.e., single) component or an assembly of components. In the example shown, the frame 102 is an assembly of components formed by at least one post 105 and at least one shelf 110 of the cart 100. For example, each shelf 110 is coupled with at least one of the posts 105 to support the shelf 110 to create the frame 102 of the cart 100. The posts 105 extend in a generally vertical direction relative to a horizontal support surface for the cart 100, and the shelves 110 can extend in a generally horizontal direction (i.e., parallel or substantially parallel to the horizontal support surface). As depicted in FIGS. 1 and 2, the cart 100 includes four posts 105 and three shelves 110. In other embodiments, a different number of posts and/or shelves may be implemented with the cart 100 (e.g., two shelves, two posts that extend a length of the cart and not four individual posts, etc.). The four posts 105 can include a first post 105 defining a first corner 115 of the cart 100, a second post 105 defining a second corner 115 of the cart 100, a third post 105 defining a third corner 115 of the cart 100, and a fourth post 105 defining a fourth corner 115 of the cart 100. Accordingly, the frame 102 of the cart 100 can have a generally rectangular shape, including a first side 120, a second side 125, a third side 130 and a fourth side 135. Although the frame 102 of the cart 100 depicted in FIGS. 1 and 2 has a generally rectangular shape, the frame 102 of the cart 100 could have a different shape (e.g., a diamond shape, a triangular shape, a trapezoidal shape, or some other shape) in other embodiments. Further, in other examples the frame 102 of the cart 100 can include a shape that is not defined by the posts 105 but is instead defined by a shape of the shelves 110, for example. In yet other examples and as alluded to above, the cart 100 can include more than four posts 105, fewer than four posts 105, greater than three shelves 110, or fewer than three shelves 110.

The cart 100 includes a top 140 and a bottom 145. The top 140 of the cart 100 is defined by a shelf 110, shown as top shelf 150. The bottom 145 of the cart is defined by a shelf 110, shown as bottom shelf 155. The cart 100 includes one or more movable elements that facilitate movement of the cart. In the example shown, the movable elements are structured as wheels 160 that are coupled with the bottom shelf 155 and extend from the bottom 145 of the cart 100. In other embodiments, the movable elements may be movable tracks or other movable elements. The wheels 160 movably support the cart 100 on a ground or support surface so that the cart can move (e.g., roll, slide, glide, travel) along the ground surface. In this way, the cart 100 is not permanently stationary. One or more of the wheels 160 can be pivotable relative to the bottom shelf 155 (e.g., about a generally vertical axis) to allow the cart 100 to turn (e.g., to change a direction in which the cart 100 moves) as well as rotatable about a generally horizontal axis to allow the cart 100 to move along the ground surface. In some embodiments, one or more of the wheels 160 can only be rotatable about the generally horizontal axis. One or more of the wheels 160 can include a lock to selectively prohibit the rotation of the wheel 160 to prevent the cart 100 from moving. For example, the wheel 160 can include a foot-operated locking mechanism. In the example shown, the wheels 160 are 6″ rubberized caster wheels with a smooth rubberized surface or some other type of wheel.

Each post 105 is an elongated vertical or substantially vertical post. For example, the posts 105 are shown as elongated vertical members having a generally L-shaped profile such that each post defines a corner. With a generally L-shaped profile, the post 105 includes two sides 107 that are oriented perpendicularly to each other. The posts 105 can be substantially symmetrical such that a first side 107 includes most or all of the same features as the second side 107, although certain differences may exist. In other embodiments, one or more of the posts 105 could have a different shape or profile, such as a circular tube, a C-shaped profile, or some other profile. In yet other embodiments, the cart 100 could include four posts 105 that define the corners 115 of the cart 100 as well as additional posts 105 positioned along the sides (e.g., the first side 120, second side 125, third side 130, or fourth side 135) of the cart 100. The posts 105 are coupled to each of the shelves 110 to form the frame 102. The posts 105 can be made from 16-gauge steel, according to an exemplary embodiment.

As shown in FIGS. 1 and 2, among others, the posts 105 include the first side 107, the second side 107, at least one top protrusion 165, at least one intermediate protrusion 167, and at least one bottom protrusion 169. For example, according to an exemplary embodiment in which the first side 107 and the second side 107 are substantially symmetrical, the post 105 includes a top protrusion 165 extending from each of the first side 107 and the second side 107, an intermediate protrusion 167 extending from each of the first side 107 and the second side 107, and a bottom protrusion extending from each of the first side 107 and the second side 107. Each of the top protrusion 165, the intermediate protrusion 167, and the bottom protrusion 196 define at least one aperture 170. The aperture 170 can be a hole (e.g., opening, aperture, passageway) formed through the post 105. According to an exemplary embodiment, the aperture 170 has a circular shape. In yet other embodiment, the aperture 170 can include a different shape (e.g. ovular, rectangular, or some other shape.

Both the top shelf 150 and the bottom shelf 155 can be supported by the posts 105 of the cart 100. For example, the top shelf 150 and the bottom shelf 155 define apertures that enable coupling to the posts (e.g., via one or more fasteners). According to an exemplary embodiment, the top shelf 150, the bottom shelf 155, or any other shelf 110 configured for use with the cart 100 defines at least one aperture (e.g., a threaded hole) that corresponds to the aperture 170 of the posts 105. Specifically, the top shelf 150 of the cart 100 can include at least one aperture that correspond with the aperture(s) 170 of the top protrusions of the posts 105 so that a fastener (e.g., a bolt, a screw, a clevis pin, a quick-release pin, or some other fastener) can be inserted through the aperture 170 of the post 105 and into the top shelf 150. Likewise, the bottom shelf 155 can include at least one aperture that correspond with the aperture(s) 170 of the top protrusions of the posts 105 so that a fastener (e.g., a bolt, a screw, a clevis pin, a quick-release pin, or some other fastener) can be inserted through the aperture 170 of the post 105 and into the top shelf 150. According to an exemplary embodiment, the top protrusion 165, the intermediate protrusion 167, and the bottom protrusion 169 of the post 105 increase an area of the post 105 that abuts the respective shelf 110 (e.g., the top shelf 150 or the bottom shelf 155). This increased area in turn allows for two or more fasteners to be coupled to the respective shelf 110 via the apertures 170 on each side 107 of the post 105. By providing a greater area that can be used to couple the shelves 110 to the posts 105, the shelves 110 can be more reliably (e.g., more rigidly) secured to the posts 105, which in turn bolsters the structural rigidity of the frame 102 of the cart 100.

Each of the posts 105 further includes/defines at least one opening or aperture, shown as slot 175. For example, the posts 105 can include multiple slots 175 positioned variously along the length of the post 105. The slot 175 is shown as an opening, aperture, or passageway extending entirely through the post 105. For example, the post 105 can define the slot 175 as a cutout within the post 105. The slot 175 includes an elongated, rectangular shape, according to an exemplary embodiment. In other embodiments, the posts 105 include at least one opening that is not a rectangular slots but is instead an opening of some other shape or profile (e.g., ovular, circular, diamond-shaped, or otherwise shaped). As depicted in FIGS. 1 and 2, among others, the posts 105 include multiple slots 175 that are aligned along the length of the post 105 such that the slots 175 are arranged in a vertical line. In other embodiments, the posts 105 include slots 175 that are not all aligned along the length of the post 105. For example, the posts 105 can include slots 175 that are positioned variously along the vertical length of the post 105 and/or positioned variously along a horizontal width of the post 105. The post 105 can further include a notch 172. The notch 172 can be a bottle opener defined by the post 105. For example, the notch 172 can engage the cap of a bottle (e.g., a beer bottle, a soda bottle, etc.) provide a surface against which a user can pry open the cap of the bottle.

The top shelf 150 of the cart 100 includes a first side 152 and a second side 154. The first side 152 and the second side 154 are opposite sides. For example, as depicted in FIGS. 1 and 2, the first side 152 is shown as the outward-facing side of the top shelf 150, whereas the second side 154 is shown as the underside of the top shelf 150. In the example shown and beneficially, the top shelf 150 is a reversible shelf, meaning that either the first side 152 or the second side 154 of the top shelf 150 can be selectively positioned as the outward-facing side of the top shelf 150. Advantageously, the top shelf 150 includes the first side 152 that defines a generally planar (e.g., flat) and uniform surface. The first side 152 can be substantially aligned with a top of the posts 105 to define the top 140 of the cart 100. The second side 154 of the top shelf 150 can include an at least partially concave or recessed geometry. Specifically, the second side 154 of the top shelf 150 can include an outer perimeter that is raised relative to a central portion such that a lip (e.g., ridge, sidewall) borders a central portion of the second side 154. In this way, the second side 154 has a non-uniform surface where the lip is raised relative to the central portion in order to prevent objects (e.g., bolts, screws, drill bits, or other objects) from rolling off of the top shelf 150 when the top shelf 150 is oriented with the second side 154 as the outward-facing side. In other examples, either of the first side 152 or the second side 154 can have some other shape, profile, geometry, or surface. For example, the first side 152 can define a generally flat surface, while the second side 154 can include multiple cutouts, grooves, impressions, or other features that can serve as an organizer for tools, fasteners, or other objects that might be frequently used in an industrial setting.

As shown in FIGS. 1 and 2, the cart 100 can include one more shelves 110 (e.g., support structures or members) between the top shelf 150 and the bottom shelf 155, shown as intermediate shelf 173. The intermediate shelf 110 can be positioned at an intermediate vertical position so as to align with the intermediate protrusion 167 of the posts 105. Alignment of the intermediate shelf 173 with the intermediate protrusion 167 of the posts 105 can provide for a more secure coupling of the intermediate shelf 173 with the posts 105, which can further enable the cart 100 to be used in industrial settings where heavy objects might be placed on (and be supported by) the intermediate shelf 173. In other examples, the intermediate shelf 173 can be positioned at some other vertical position on the posts 105 (e.g., any other position between the top protrusion 165 and the bottom protrusion 169 of the posts 105). In yet other examples, the cart 100 can include multiple intermediate shelves 173 positioned variously along the posts 105 according to a user's desire.

The top shelf 150, the bottom shelf 155, the intermediate shelf 173, and/or any other shelves 110 can be or include an organic material such as wood, bamboo, or other material. In other examples, the top shelf 150, the bottom shelf 155, the intermediate shelf 173, and/or any other shelves 110 can be or include an inorganic material, such as a plastic or polymeric material, a composite material, a metallic material, or some other material. In various embodiments, the top shelf 150, the bottom shelf 155, the intermediate shelf 173, and/or any other shelves 110 can be partially magnetic to allow for the magnetic attachment of tools or other objects to the respective shelf. Further, each of the top shelf 150, the bottom shelf 155, or the intermediate shelf 173 can include a rubberized pad or a rubberized surface to prevent objects supported by the respective shelf from moving relative to the shelf.

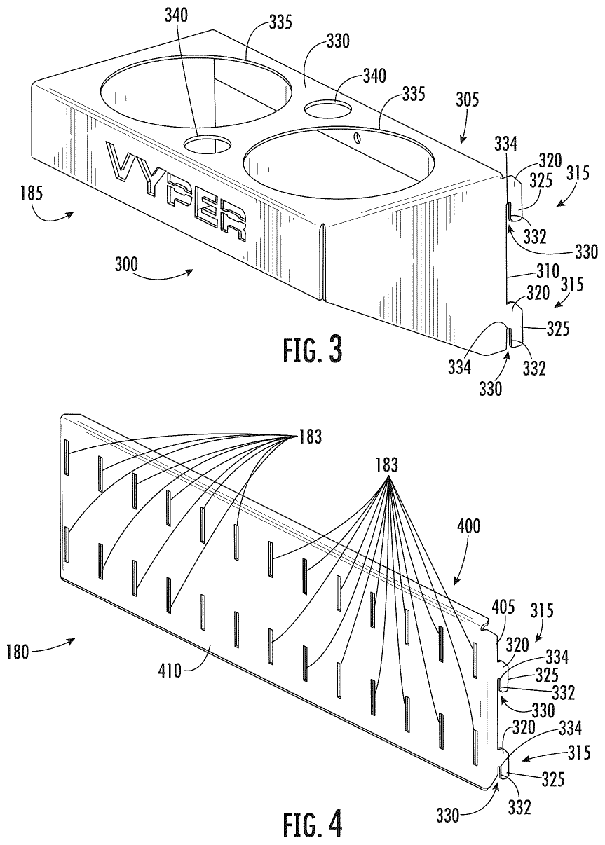

The cart 100 further includes at least one panel 180, at least one at least one accessory device 185, and at least one handle 190. As discussed in detail below with reference to FIGS. 3-5, the panel 180 is removably coupled to the frame 102 of the cart 100. More specifically, the panel 180 is removably coupled with the posts 105 of the frame 102 via the slots 175 of the posts 105, as is discussed in detail below. As discussed in detail below with reference to FIGS. 3-5 and 17, the accessory device 185 is removably coupled to the panel 180. For example, the panel 180 can include or define at least one opening 183, shown as slot 183. The slot 183 can resemble the slot 175 of the post 105. For example, the slot 183 can include a form (e.g., size, shape, geometry) that is substantially identical (e.g., +15% dimensional variance) to the slot 175 of the post 105. Further, the accessory device 185 can be configured to be removably coupled to the frame 102 of the cart 100 (i.e., rather than coupling to a panel 180 that is itself coupled to the frame 102 of the cart 100.) In various embodiments the accessory device 185 is coupled with the panel 180 via the slots 183 of the panel 180, as is discussed in detail below. In other embodiments, the accessory device 185 is coupled with the frame 102 of the cart 100 via the slots 175, as is discussed in detail below. The accessory device 185 can take any number of different forms (e.g., shapes, sizes, having a variety of different features) so facilitate the broad customization of the cart 100 to suit a particular setting. The handle 190 is coupled to the frame 102 of the cart 100 proximate the top 140 of the cart 100 to facilitate movement of the cart 100, for example. The handle 190 is shown as having a generally cylindrical shape, but it is understood that the handle 190 could take various other forms and shapes.

The frame 102 of the cart 100 includes a length, a width, and a height. The length can be a distance from one post 105 (e.g., a first post 105) to another post 105 (e.g., a second post 105). Similarly, the width can be a distance from one post 105 (e.g., the second post 105) to another post 105 (e.g., a third post 105). The height of the frame 102 can be approximately equal to the vertical length of the posts 105. As depicted in FIGS. 1 and 2, the width is less than the length because the cart 100 includes the rectangular shape. In other embodiments, frame 102 of the cart 100 can include the length, the width, or the height different from the general proportions shown.

The cart 100 can include multiple panels 180. As depicted in FIGS. 1, 2, and 17, among others, the cart 100 can include multiple panels 180 coupled to multiple sides of the cart 100. For example, the cart 100 shown in FIGS. 1 and 2 includes two panels 180 coupled to the second side 125 of the cart 100 and a single panel 180 coupled with the fourth side 135 of the cart 100. In other embodiments, the cart 100 can include additional panels 180 or fewer panels 180. For example, the cart 100 can include a panel 180 substantially spanning the length of the first side 120 of the cart 100 in addition to or instead of one or more panels 180 coupled with the second side 125, the third side 130, or the fourth side 135.

The panels 180 can be of varying size or shape. For example, as shown in FIG. 1, the cart 100 can include a first panel 180 having a first height and a second panel 180 having a second height, where the second height is greater than the first height. In exemplary embodiments, the panels 180 can have a width that is approximately (e.g., +15%) equal to a dimension of the associated side of the cart 100. For example, a panel 180 coupled with the second side 125 includes the width that is approximately equal to a width of the second side 125 (e.g., the width of the cart 100). Likewise, a panel 180 coupled with the first side 120 of the cart 100 includes a width that is approximately equal to a width of the first side 120 (e.g., the length of the cart 100). In this way, the panel 180 can extend from one post 105 of the frame 102 to another post 105 of the frame 102 to facilitate coupling of the panel 180 to the frame 102.

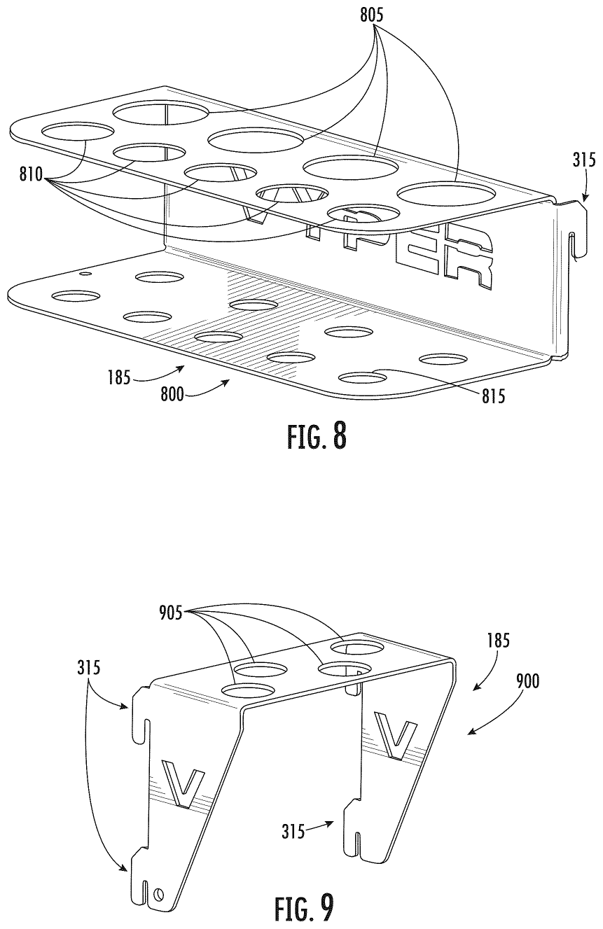

Referring now to FIG. 3, a detailed perspective view of the accessory device 185, shown as accessory device 300, is depicted, according to an example embodiment. Although the accessory device 300 depicted in FIG. 3 includes a certain shape, form factor, function, and size, it should be understood that the cart 100 can include one or more accessory devices 185 or no accessory devices 185, as the case may be. For example, as demonstrated by accessory devices 185 shown in FIGS. 8-16, a wide variety of accessory devices 185 are possible (i.e., including accessory devices not explicitly depicted or described herein). Beneficially, the cart 100 offers vast customization capabilities, which allows a user to include or exclude whichever accessory devices 185 may be necessary for a particular task. Further and as will be discussed, the cart 100 offers vast customization capabilities for positioning an accessory device 185 on the cart. The features of the accessory device 185 depicted in FIG. 3 should be understood as being equally applicable to the accessory devices depicted in FIGS. 8-16 or to any other accessory devices 185.

The accessory or accessory device, apparatus, component, etc. 185 (e.g., the accessory device 300, the accessory devices shown in FIGS. 8-17, or other accessory devices) includes at least one prong 315 extending from a rear side 305 of the accessory device 185. For example, the accessory device 185 can include the prong 315 extending substantially perpendicular to the rear 305 (e.g., backside, rear surface) from an edge 310 of the accessory device 185. In other examples, the prong 315 extends from another portion of the rear 305 of the accessory device 185 (e.g., a position between edges 310 of the accessory device 185). The accessory device 185 can include two or more prongs 315. For example, the accessory device 185 can include two prongs 315 extending from each vertical edge 310, where the two prongs 315 on each edge 310 are vertically aligned. In other embodiments, the accessory device 185 can include more or fewer prongs 315.

The prong 315 includes a first portion 320 and a second portion 325. The first portion can extend outward (e.g., rearward) from the rear of the accessory device 185. In exemplary embodiments, the first portion 320 extends perpendicular to a plane defined by the rear 305 of the accessory device 185. For example, the first portion 320 extends straight outward (e.g., horizontally outward) from the rear 310 of the accessory device 185 rather than extending at some other angle (e.g.,) 45° relative to a plane defined by the rear 310 of the accessory device 185. The second portion 325 of the prong 315 extends from the first portion 320 of the prong 315. More specifically, the second portion 325 extends substantially perpendicularly (e.g., +15° from perpendicular) relative to the first portion 320 of the prong 315, as shown in FIG. 3. For example, if the first portion 320 of the prong 315 extends horizontally outward from the rear 310 of the accessory device 185, the second portion 320 can extend perpendicularly from the first portion 320 in a substantially downward (e.g., vertical) direction.

The first portion 320 and the second portion 325 of the prong 315 can collectively define a notch 330 of the prong 315. The notch 330 of the prong 315 can be a recessed region positioned horizontally between an inner edge 332 of the second portion 325 and the rear 310 of the accessory device 185. The notch 330 is further positioned vertically below an inner edge 334 of the first portion 320. The notch can include a width 333 that is approximately equal to a thickness of the panel 180 or a thickness of the post 105. In embodiments where the second portion 325 is a generally linear member, the inner edge 332 can be a generally straight edge. In other embodiments, the inner edge 332 can have a rounded profile, a textured profile, or some other non-linear profile. Likewise, the inner edge 334 can be a generally straight edge or can include a rounded profile, a textured (e.g., non-uniform) profile, or some other non-linear profile.

The accessory device 185 can include one or more features to facilitate the storage, organization, and/or support of various tools, parts, fasteners, or other objects that may be used in the industrial or other setting. For example, the particular accessory device 185 of FIG. 3, shown as accessory device 300, includes a top 335 defining a multiple cutouts 340. The cutouts 340 can be generally circular apertures formed through the top 335 of the accessory device 300 that can be configured to support a cup, can, bottle, some other beverage container, or some other object that is cylindrical or otherwise, for example. In some examples (not shown), the cutout 340 can be lined with an insulative material (e.g., a foam material) to keep a beverage cold while positioned within the cutout 340. In other examples, the accessory device 300 includes additional cutouts 345 to support other objects such as screwdrivers, hammers, or other objects. For example, the cutouts 340 can have a different size than the cutouts 345 such that the accessory device 300 can support a variety of differently sized objects.

FIG. 4 depicts the panel 180 in detail. As noted above, the panel 180 includes at least one opening 183, shown as the slot 183. According to an exemplary embodiment, the panel 180 includes multiple slots 183. The slots 183 are arranged in a grid-like pattern, where each slot is horizontally aligned with at least one other slot 183 and vertically aligned with at least one other slot 183. The slot 183 is shown as an opening, aperture, or passageway extending entirely through the panel 180. For example, the panel 180 can define the slot 183 as a cutout within the panel 180. The slot 183 includes an elongated, rectangular shape, according to an exemplary embodiment. In other embodiments, the panel 180 includes at least one opening that is not a rectangular slot but is instead an opening of some other shape or profile (e.g., ovular, circular, diamond-shaped, or otherwise shaped). As depicted in FIG. 4, among others, the panel 180 include multiple slots 183 that are positioned along a width of the panel 180 and along a height of the panel 180. In this way, the slots 183 are positioned over a substantial portion of the panel 180 (e.g., proximate to each outer edge of the panel 180). Each of the slots 183 of the panel 180 can be substantially identical to each other. Or, in other embodiments, the slots 183 of the panel can include various sizes, shapes, or profiles. The panel 180 further includes an outer surface 410.

The panel 180 further includes at least one prong 315 extending from a rear side 400 of the panel 180. For example, the panel 180 can include the prong 315 extending substantially perpendicular to the rear 400 (e.g., backside, rear surface) from at least one edge 405 of the panel 180. In other examples, the prong 315 extends from another portion of the rear 400 of the panel 180 (e.g., a position between edges 405 of the rear 400 of the panel 180). The panel 180 can include two or more prongs 315. For example, the panel 180 can include two prongs 315 extending from each vertical edge 405, where the two prongs 315 on each edge 405 are vertically aligned. In other embodiments, the panel 180 can include more or fewer prongs 315. According to an exemplary embodiment, the prongs 315 can be positioned proximate the edge 405 of the panel 180. Further, the panel 180 can include a width that is approximately equal to a distance between slots 175 of adjacent posts 105. As noted above, the panel 180 can substantially span the width of the side of the cart 100 to which it is coupled such that a width of the panel 180 is approximately equal (e.g., +15%) the width of the relevant side of the cart 100. Because the panel 180 substantially spans the width of a side of the cart 100, the panel 180 can couple with two posts 105 that define the relevant side of the cart 100. For example, the panel 180 can couple with two posts 105 of the cart 100 to span a side of the cart 100.

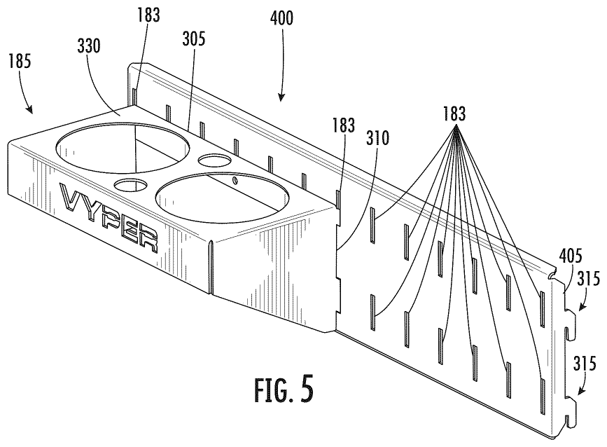

The prongs 315 of the accessory device 185 can be positioned to correspond with the openings 183 (e.g., the slots 183) of the panel 180. For example, as depicted in FIG. 5, among others, the accessory device 185 is configured to couple with the panel 180. Specifically, the prong 315 of the accessory device 185 is configured to engage the slot 183 of the panel 180 to couple the accessory device 185 to the panel 180. In examples where the accessory device 185 includes two prongs 315 that are not vertically aligned (i.e., are horizontally spaced from each other), each prong 315 can correspond to a slot 183 of the panel 180. Put another way, a spacing of the slots 183 of the panel 180 can correspond to a spacing of the prongs 315 of the accessory device 185. So, while the embodiment of FIG. 5 depicts the accessory device 185 positioned on a left side of the panel 180, the accessory device 185 could be positioned to a right side of the panel 180, in a central portion of the panel 180, or otherwise positioned. Further, the panel 180 can include multiple rows of slots 183 so that a vertical position of the accessory device 185 relative to the panel 180 can be varied. For example, the accessory device 185 can engage with a bottom row of slots 183 of the panel 180, a top row of slots 183 of the panel, or an intermediate row or rows of slots 183 of the panel 180.

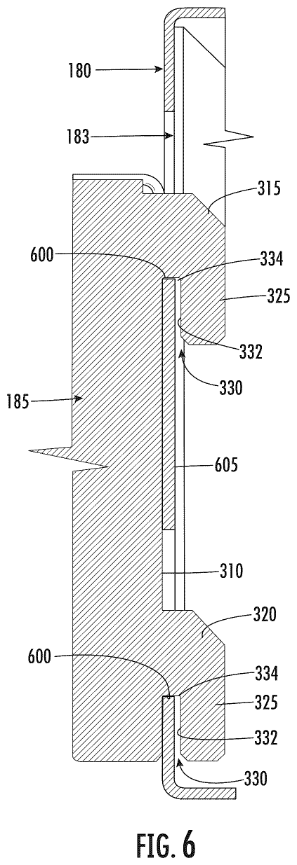

Referring now to FIG. 6, a cross-sectional view of the accessory device 185 coupled with the panel 180 is shown, according to an example embodiment. One or more prongs 315 of the accessory device 185 can engage with one or more slots 183 of the panel 180 in order to removably couple the accessory device 185 with the panel 180. As discussed above, each prong 315 of the accessory device 185 can include the notch 330 that is configured to receive a bottom edge 600 of a corresponding slot 183 of the panel 180. Specifically, for the selected slots 183 of the panel 180, the bottom edge 600 of the slot 183 can contact the inner edge 334 of the first portion 320 of the corresponding prong 315. The inner edge 332 of the second portion 325 of each corresponding prong 315 can contact a backside 605 of the panel 180. For example, the inner edge 332 of the second portion 325 of the prongs 315 of the accessory device 185 can temporarily contact the backside 605 of the panel 180 or can be in static (e.g., stationary, fixed, enduring) contact with the backside 605 of the panel 180. Furthermore, the rear 305 of the accessory device 185 can contact the outer surface 410 of the panel 180, whether said contact is dynamic (e.g., temporary, momentary) or static (e.g., stationary, fixed, enduring). In this way, the accessory device 185 is coupled to the panel 180 via multiple points of contact, which bolsters a strength and rigidity of the engagement between the accessory device 185 and the panel 180. This, in turn, means that heavy objects can be supported by the accessory devices 185 that are coupled to the panel 180.

The engagement of the accessory device 185 with the panel 180 is detachable such that the accessory 185 may be removed and re-attached to the panel 180 in various positions or orientations. In other words, the accessory device 185 can be selectively removed from the panel 180. For example, by translating the accessory device 185 in a vertical (e.g., upward) direction relative to the panel 180, the bottom edge 600 of the slot 183 can disengage from the inner edge 334 of the first portion 320 of the prong 315 of the accessory device 185. Likewise, the backside 605 of the panel 180 can disengage from the inner edge 332 of the second portion 325 of the prong 315. With the bottom edge 600 of the slot 183 and the backside 605 of the panel 180 disengaged from the prong 315 of the accessory device 185, the prong 315 can be removed from the slot 183 to detach the accessory device 185 from the panel 180. Because the accessory device 185 can be easily coupled with and decoupled from the panel 180, the cart 100 is highly customizable. For example, the accessory 185 can be engaged with various of the slots 183 of the panel 180 to raise or lower a vertical position of the accessory device 185 relative to the panel, alter a horizontal position of the accessory device 185 relative to the panel 180, or arrange multiple accessory devices 185 in various positions on the panel 180 or panels 180 of the cart 100.

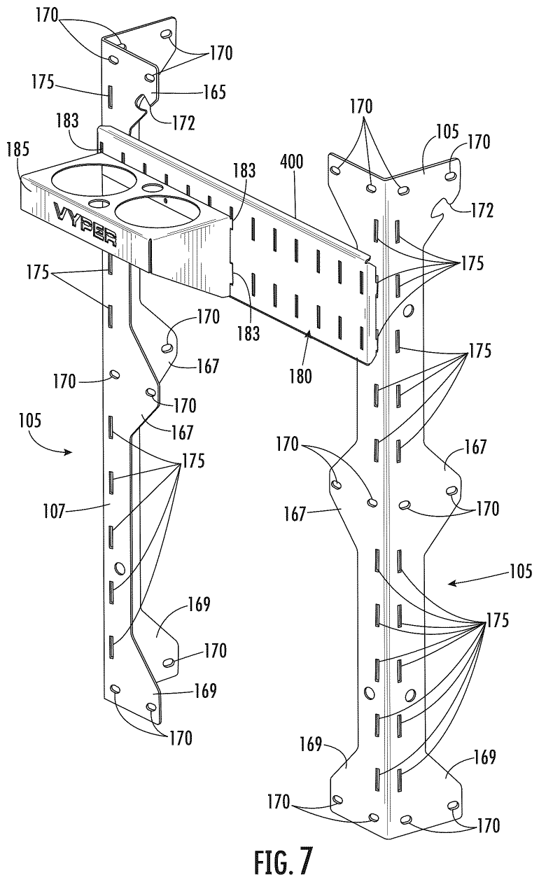

As depicted in FIG. 7, the panel 180 can couple with a first post 105 and a second post 105 of the frame 102 of the cart 100. Specifically, the panel 180 can include at least one first prong 315 extending from a first edge 405 of the panel 180. The panel 180 can further include at least one second prong 315 extending from a second edge 405 of the panel 180. A distance between the first prong 315 and the second prong 315 can be approximately equal to a horizontal distance between a slot 175 of the first post 105 and a slot 175 of the second post 105. In this way, the panel 180 can couple with the first post 105 and the second post 105 via engagement between the first prong 315 of the panel 180 with the slot 175 of the first post 105 and engagement between the second prong 315 of the panel 180 with the slot 175 of the second post 105. Similar to the engagement of the prong 315 of the accessory device 185 with the slot 183 of the panel 180 discussed above with reference to FIG. 6, the prong 315 of the panel 180 can include the notch 330 that is configured to receive a bottom edge of the slot 175 (e.g., similar to the bottom edge 600 of the slot 183) of the first post 105 and a bottom edge of the slot 175 of the second post 105. Specifically, the bottom edge of the slot 175 of the first post 105 can contact the inner edge 334 of the first portion 320 of the first prong 315. Likewise, the bottom edge of the slot 175 of the second post 105 can contact the inner edge 334 of the first portion 320 of the second prong 315. The inner edge 332 of the second portion 325 of the first prong 315 and the inner edge 332 of the second portion 325 of the second prong 315 can contact a backside of the first post 105 and the second post 105, respectively. Furthermore, the rear 400 of the panel 180 can contact an outer surface of the first post 105 and an outer surface of the second post 105. In this way, the panel 180 is coupled to the first post 105 and the second post 105 via multiple points of contact, which bolsters a strength and rigidity of the engagement between the panel 180 and the posts 105. This, in turn, means that heavy objects can be supported by the accessory devices 185 that are coupled to the panel 180.

Like the engagement of the accessory device 185 with the panel 180, the engagement of the panel 180 with the posts 105 is a removable engagement. Meaning, the panel 180 can be selectively removed from the posts 105. For example, by translating the panel 180 in a vertical (e.g., upward) direction relative to the posts 105, the bottom edge of the slot 175 can disengage from the inner edge 334 of the first portion 320 of the prong 315. Likewise, the backside of the post 105 can disengage from the inner edge 332 of the second portion 325 of the prong 315. With the bottom edge of the slot 175 and the backside of the post 105 disengaged from the prong 315 of the panel 180, the prong 315 can be removed from the slot 175 to detach the panel 180 from the posts 105. Because the panel 180 can be easily coupled with and decoupled from the posts 105, the cart 100 is highly customizable. For example, the panel 180 can be engaged with various of the slots 175 of the posts 105 to raise or lower a vertical position of the panel 180 or to accommodate multiple panels 180 on a single side of the cart 100.

FIG. 8 depicts another accessory or accessory device 185, shown as accessory device 800. The accessory device 800 includes at least one upper opening 805 and at least one upper opening 810 formed in a top surface of the accessory device 800. The upper opening 805 and the upper opening 810 can be circular openings or can have some other shape or geometry. The upper opening 805 and the upper opening 810 can be differently sized and, in other embodiments, be similarly sized. For example, the upper opening 805 can be larger than the upper opening 810. The accessory device 800 further includes at least one lower opening 815. The lower opening 815 can be axially aligned with the upper opening 805 or the upper opening 810 such that a common axis can pass through the upper opening 805 and the lower opening 815 or through the upper opening 810 and the lower opening 815. The accessory device 800 can be configured to hold or store one or more tools such as screw drivers or other elongated members. For example, a tip of a screw driver can extend through lower opening 815, while a shank of the screw driver can extend through the upper opening 805 or the upper opening 810. The top of the accessory device can support the handle of the screw driver, for example. In other examples, the accessory device 800 can be configured to support some other tool or object as per a user's desire.

FIG. 9 depicts another accessory or accessory device 185, shown as accessory device 900. The accessory device 900 includes at least one opening 905 formed through a top surface or top plate of the accessory device 900. The accessory device 900 can be configured to support one or more tools or other objects. For example, a handle of a brush, scrubber, or other tool can be inserted through the opening 905 such that the top surface of the accessory device will support a head or body of the brush or other device. In other examples, the accessory device 900 can be configured to support some other tool or object as per a user's desire.

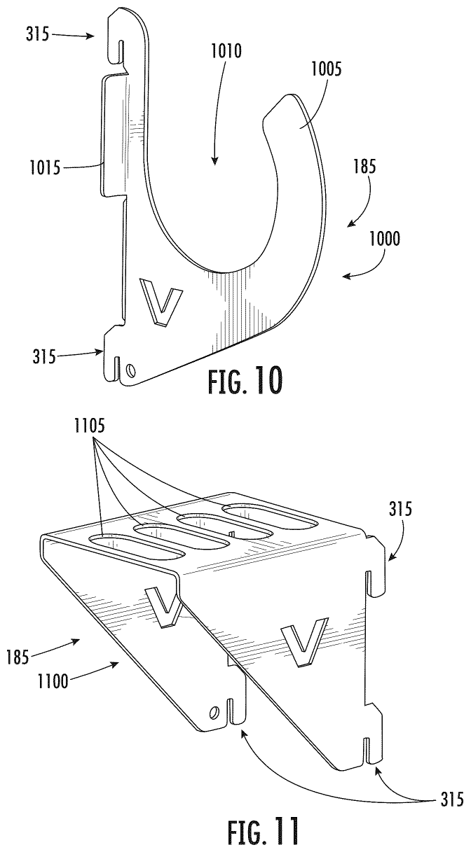

FIG. 10 depicts another accessory or accessory device 185, shown as accessory device 1000. The accessory device 1000 includes at least one hook member 1005 projecting outward and upward from the prongs 315 of the accessory device 1000. The hook 1005 defines a recessed area 1010. For example, an object can be hung on the accessory device 1000 to stow the object on the cart 100. Specifically, the recessed area 1010 of the accessory device 1000 can support an extension cord, bungee cables, ratchet straps, chain, or cord-like objects. In other examples, the accessory device 1000 can be configured to support some other tool or object as per a user's desire. As depicted in FIG. 10, among others, the accessory device 1000 can include multiple prongs 315 that are vertically aligned (i.e., positioned along a common vertical axis). To support the accessory device 1000 against the panel 180 or the post 105 of the cart 100 and to prevent the accessory device 1000 from pivoting of swiveling relative to the panel 180 or the post 105, the accessory device 1000 includes one or more flanges 1015 extending horizontally from the accessory device 1000 (i.e., perpendicularly relative to the prong 315). The flange 1015 can contact the outer surface 410 of the panel 410, for example.

FIG. 11 depicts another accessory or accessory device 185, shown as accessory device 1100. The accessory device 1100 includes at least one opening 1105. The opening 1105 can have an oval shape, an elliptical shape, or some other shape. The accessory device 1100 can be configured to support one or more tools such as pliers, scissors, tin snips, wire strippers, or other devices having a tip (e.g., a working end of a pliers) that is narrower than a handle. For example, the tip of the tool can be inserted through the opening 1105 in a downward direction. In this configuration, an edge of the opening 1105 can support the handle of the tool to store the tool on the cart 100. In other examples, the accessory device 1100 can be configured to support some other tool or object as per a user's desire.

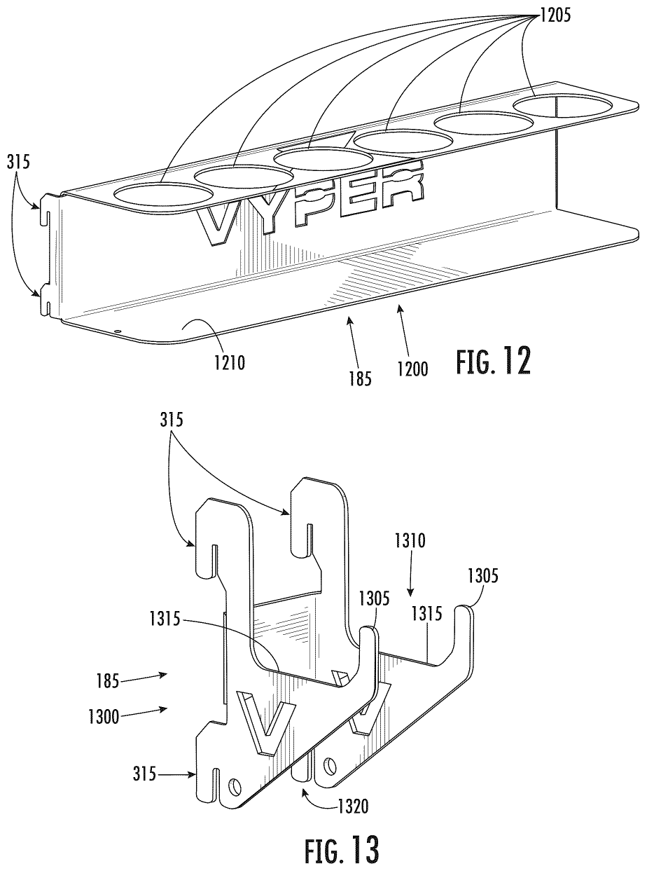

FIG. 12 depicts another accessory or accessory device 185, shown as accessory device 1200. The accessory device 1200 includes at least one opening 1205 defined in a top surface or top plate of the accessory device 1200. The accessory device 1200 further includes a bottom plate 1210. The accessory device 1200 can be configured to support one or more bottles, canisters, or other cylindrical objects. For example, an object can be inserted through the opening 1205 and supported by the bottom plate 1210. Specifically, the bottom plate 1210 can support the weight of the object, while a perimeter of the opening 1205 can prevent the object from falling (e.g., sliding, moving) off of the accessory device 1200 during operation of the cart 100. In other examples, the accessory device 1200 can be configured to support some other tool or object as per a user's desire.

FIG. 13 depicts another accessory or accessory device 185, shown as accessory device 1300. The accessory device 1300 includes at least one hook 1305 defining at least one recessed region 1310. The recessed region 1310 further includes a supporting edge 1315. For example, an object can be hung on the accessory device 1300 to stow the object on the cart 100. Specifically, the recessed area 1310 of the accessory device 1300 can support an extension cord, bungee cables, ratchet straps, chain, or cord-like objects via the supporting edge 1315. As shown in FIG. 13, the accessory device 1300 includes two hooks 1305, each defining a recessed area 1310 having a supporting edge 1315. A space 1320 can be defined between the two hooks 1305. Accordingly, the accessory device 1300 can be configured to support a hammer, mallet, pry bar, or other object, where a head of the object (e.g., head of a hammer) rests on the two supporting edges 1315 as a handle (e.g., an elongated handle of a hammer) extends downward between the two hooks 1305 within the space 1320. In yet other examples, the accessory device 1300 can be configured to support some other tool or object as per a user's desire.

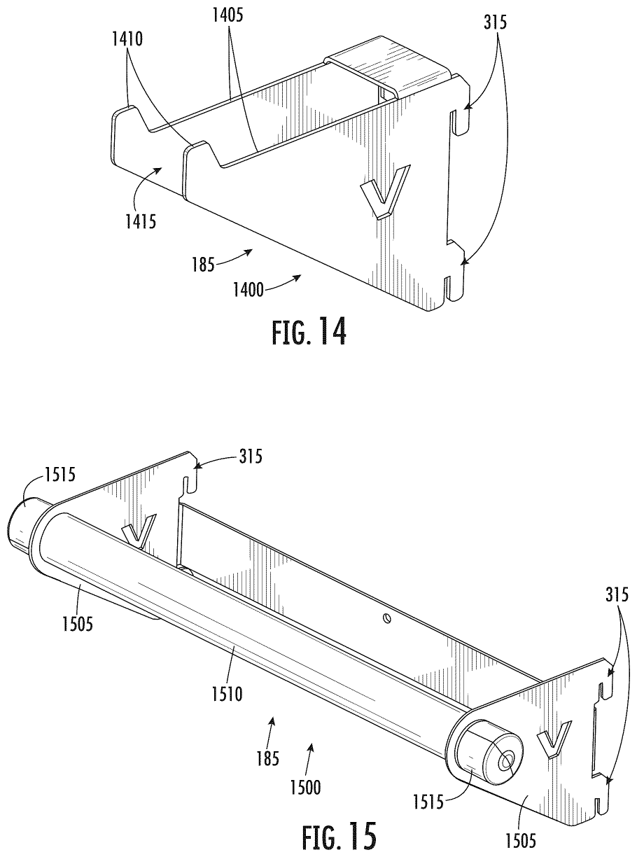

FIG. 14 depicts another accessory or accessory device 185, shown as accessory device 1400. The accessory device 1400 includes two parallel supporting members 1405. Each supporting member 1405 includes a raised end 1410. A space 1415 is defined between the two supporting members 1405. Similar to the accessory device 1300, the accessory device 1400 can be configured to support a hammer, mallet, pry bar, or other object, where a head of the object (e.g., head of a hammer) rests on the two supporting members 1405 as a handle (e.g., an elongated handle of a hammer) extends downward between the two supporting members 1405 within the space 1415. Further, the raised ends 1410 of each supporting member 1405 can prevent the hammer or other supported object from sliding off of the supporting members 1405 during operation of the cart 100. In other examples, the accessory device 1400 can be configured to support some other tool or object as per a user's desire.

FIG. 15 depicts another accessory or accessory device 185, shown as accessory device 1500. The accessory device 1500 includes two supporting members 1505 and at least one bar 1510. As depicted in FIG. 15, among others, the supporting members 1505 are substantially parallel and the bar 1510 extends from one supporting member 1505 to the other supporting member 1505. For example, the bar 1510 can extend through openings formed within each of the supporting members 1505. The bar 1510 can be oriented to be substantially perpendicular to the supporting members 1505. The bar 1510 can be selectively coupled with the supporting members 1505. For example, cap 1515 positioned on either end of the bar 1510 can retain the bar 1510 relative to the supporting members 1505. Removal of the cap 1515 can permit the bar 1510 to slide relative to the supporting member 1505 to remove the bar 1505 or to expose an end of the bar 1510. For example, an end of the bar 1510 can be exposed so that a roll of paper towel or other paper product can be inserted on to the bar 1510. Accordingly, the accessory device 1500 can support a roll of paper towel or some other rolled item. In other examples, the accessory device 1500 can be configured to support some other tool or object as per a user's desire.

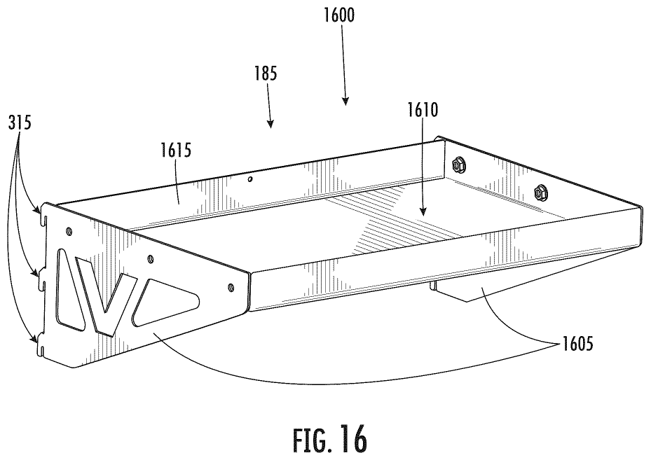

FIG. 16 depicts another accessory or accessory device 185, shown as accessory device 1600. The accessory device 1600 includes at least one tray 1610 supported by two or more supporting members 1605. For example, the accessory device 1600 can include two supporting members 1605 positioned on either side of the tray 1610 to support the tray 1610. The tray 1610 can include a lip or edge 1615 to retain objects (e.g., fasteners, tools) that are positioned on the tray 1610. The tray 1610 can be coupled the cart 100 to provide additional workspace area for a user, for example. In other examples, the accessory device 1600 can be configured to support some other tool or object as per a user's desire. The tray 1610 may include a relatively flat or planar surface. In other embodiments, the work surface of the tray 1610 may take a variety of different forms (e.g., include raised projections to separate certain work zones, etc.). Further, the shape and size of the accessory device 1600 may differ in other embodiments.

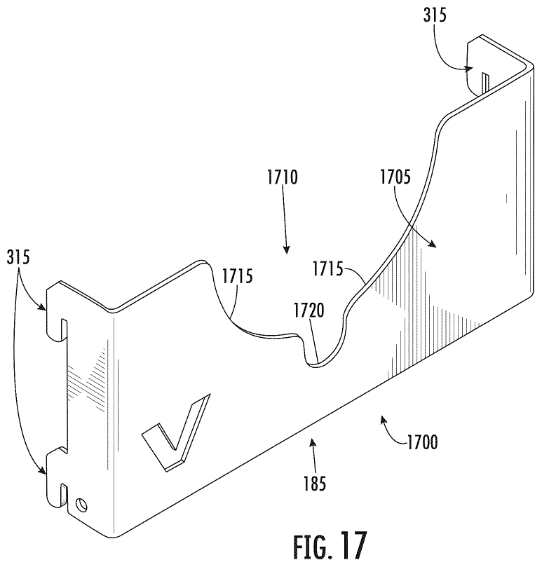

FIG. 17 depicts another accessory or accessory device 185, shown as accessory device 1700. The accessory device 1700 includes a body 1705 and a pocket 1710. The pocket 1710 is the space formed between the body 1705 and the panel 180 to which the accessory device 1700 can be coupled. The body 1705 can further include a first contoured edge 1715 and a second contoured edge 1720. The first contoured edge 1715 can be a generally concave region having a first radius of curvature. The second contoured edge 1720 can be a generally concave region having a second radius of curvature that is smaller than the first radius of curvature. The first contoured edge 1715 and/or the second contoured edge 1720 can be configured to support one or more tools, such as an orbital polishing tool, an angle grinder, or some other tool. For example, a polishing pad of an orbital polisher can be positioned within the pocket while a shaft of the orbital polisher can be supported by the second contoured edge 1720. The first contoured edge 1715 can extend upward behind the polishing pad to capture the polishing pad within the pocket 1710 in order to retain the orbital polisher against the accessory device 1700, for example. In other examples, the accessory device 1700 can be configured to support some other tool or object as per a user's desire.

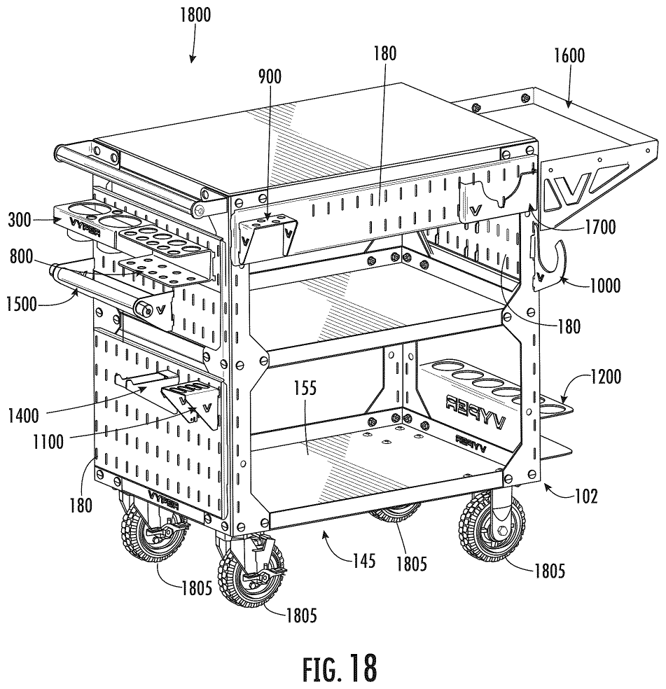

FIG. 18 depicts another cart, shown as cart 1800. The cart 1800 can be substantially similar to that of the cart 100 depicted in FIGS. 1 and 2, among others. However, the cart 1800 can include the various accessory devices 185 described herein. The accessory devices can include, but are not limited to, the accessory device 800, the accessory device 900, the accessory device 1000, the accessory device 1100, the accessory device 1200, the accessory device 1300, the accessory device 1400, the accessory device 1500, the accessory device 1600, and the accessory device 1700, among others. Each of the accessory devices 185 can be coupled with a panel 180, and each panel 180 can be coupled with the frame 102 of the cart 1800. For example, the cart 1800 can include multiple panels 180 coupled to the frame 102 of the cart 1800 on various sides of the cart 1800 such that the cart 1800 includes a vast surface area (e.g., many slots 183 of the panels 180) on which the user can couple one or more accessory devices 185. Although the accessory devices 185 are shown in FIG. 18 in a particular orientation, it is understood that the number of panels 180, the position of the panels 180 relative to the frame 102, the number of accessory devices 185, and the position of the accessory devices 185 relative to the panels 180 (or relative to the frame 102) can vary widely according to a user's preference.

The cart 1800 can include movable elements, shown as wheels 1805. Like the wheels 160 of the cart 100, the wheels 1805 are coupled with the bottom shelf 155 and extend from the bottom 145 of the cart 1800. The wheels 1805 movably support the cart 1800 on a ground surface so that the cart 1800 can move (e.g., roll, slide, glide, travel) along the ground surface. In this way, the cart 1800 is not permanently stationary. One or more of the wheels 1805 can be pivotable (e.g., permitted to swivel) relative to the bottom shelf 155 (e.g., about a generally vertical axis) to allow the cart 1800 to turn (e.g., to change a direction in which the cart 1800 moves) as well as rotatable about a generally horizontal axis to allow the cart 1800 to move along the ground surface. In some embodiments, one or more of the wheels 1805 can only be rotatable about the generally horizontal axis. One or more of the wheels 1805 can include a lock to selectively prohibit the rotation of the wheel 160 to prevent the cart 1800 from moving. For example, the wheel 1805 can include a foot-operated locking mechanism. While the wheels 160 depicted in FIGS. 1 and 2 can be rubberized caster wheels with a smooth surface, the wheels 1805 can be rubberized wheels having grooves or tread to further enhance the grip of the wheels 1805 against a ground surface. For example, the wheels 1805 can be 6″ rubberized caster wheels or some other type of wheel. In other embodiments, the carts 100 or 1800 may instead include non-movable elements (e.g., support rods) that support the cart so that the cart 100 or 1800 is relatively stationary and not as easily maneuverable.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof (e.g., example), as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that any element disclosed in one embodiment may be incorporated or utilized with any other embodiment disclosed herein. For example, the accessory devices 185 of the exemplary embodiment described in at least paragraph(s) [0051]-[0060] may be incorporated in the exemplary embodiment described in at least paragraphs [0061]-[0062] or the exemplary embodiment described in paragraphs [0026]-[0050]. As another example, the wheels 1805 of the exemplary embodiment described in at least paragraphs [0061]-[0062] can be incorporated in the exemplary embodiment described at least in paragraphs [0026]-[0050]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A cart, comprising:
a frame, comprising:
a first post defining a first plurality of slots;
a second post defining a second plurality of slots;
a first shelf defining a top of the frame, the first shelf coupled to the first post and the second post; and
a second shelf defining a bottom of the frame, the second shelf coupled to the first post and the second post;
a panel including a first prong and a second prong, the first prong removably engaged with a first slot of the first plurality of slots, the second prong removably engaged with a first slot of the second plurality of slots, the panel defining a third plurality of slots; and
a plurality of wheels coupled with the second shelf.

2. The cart of claim 1, wherein the first shelf includes a substantially planar first side opposite a second side, the second side including a recessed area defined by a sidewall, wherein the first shelf is reversibly coupled with the first post and the second post to selectively position one of the first side or the second side as the top of the frame.

3. The cart of claim 1, wherein the first shelf includes a substantially planar first side opposite a second side, the second side including a recessed area defined by a sidewall, and wherein the first side of the first shelf defines the top of the frame.

4. The cart of claim 1, wherein the first shelf includes a substantially planar first side opposite a second side, the second side including a recessed area defined by a sidewall, and wherein the sidewall of the second side defines the top of the frame.

5. The cart of claim 1, further comprising:
an accessory device including a plurality of prongs, two of the plurality of prongs configured to removably engage with at least two slots of the third plurality of slots, respectively, to couple the accessory device with the panel.

6. The cart of claim 1, wherein each slot of the first plurality of slots, the second plurality of second slots, and the third plurality of slots are substantially identical.

7. The cart of claim 1, further comprising:
a third post defining a fourth plurality of slots, wherein the first post and the second post define a first side of the cart, wherein the second post and the third post define a second side of the cart; and
a second panel including a first prong and a second prong, the first prong of the second panel configured to be removably engaged with a second slot of the second plurality of slots, the second prong configured to be removably engaged with a first slot of the fourth plurality of slots, and the second panel defining a fifth plurality of slots.

8. The cart of claim 7, wherein the first side has a length that is greater than a length of the second side, wherein the second panel has a panel length that is equal to or less than the length of the second side.

9. The cart of claim 1, wherein the first post and the second post each include a protrusion, the protrusion of the first post defining a first aperture and the protrusion of the second post defining a second aperture;
wherein the first shelf is coupled with the protrusion of the first post by a first fastener engaged with the first aperture;
wherein the first shelf is coupled with the protrusion of the second post by a second fastener engaged with the second aperture.

10. The cart of claim 1, wherein the first post includes a first protrusion and a second protrusion, the first shelf coupled with the first protrusion, the second shelf coupled with the second protrusion.

11. The cart of claim 1, wherein the first post includes a first protrusion and a second protrusion, the first shelf coupled with the first protrusion, the second shelf coupled with the second protrusion; and
wherein the first protrusion defines a notch configured to engage with a cap.

12. The cart of claim 1, wherein the first post includes a first protrusion, a second protrusion, and a third protrusion, the cart further comprising:
a third shelf positioned vertically between the first shelf and the second shelf, the third shelf coupled with the third protrusion of the first post;
wherein the first shelf is coupled with the first protrusion and the second shelf coupled with the second protrusion.

13. The cart of claim 1, wherein the first prong includes a first portion and a second portion, the first portion extending from a rear of the panel, the second portion extending from the first portion at angle relative to the first portion to define a notch between the rear of the panel and the second portion,
wherein an edge of the first slot is engaged with the notch of the first prong to couple the panel with the first post.

14. A cart, comprising:
a frame comprising:
a first post defining a first slot, the first slot having a bottom edge; and
a second post defining a second slot, the second slot having a bottom edge; and
a panel including a first prong, a second prong, and a plurality of slots, the first prong and the second prong having a first portion and a second portion, the first portion extending from a rear of the panel, the second portion extending from the first portion at angle relative to the first portion to define a notch between the rear of the panel and the second portion,
wherein the bottom edge of the first slot is engaged with the notch of the first prong to couple the panel with the first post;
wherein the bottom edge of the second slot is engaged with the notch of the second prong to couple the panel with the second post.

15. The cart of claim 14, further comprising:
a first shelf defining a top of the frame, the first shelf coupled to the first post and the second post.

16. The cart of claim 15, wherein the first shelf includes a substantially planar first side opposite a second side, the second side including a recessed area defined by a sidewall, wherein the first shelf is reversibly coupled with the first post and the second post to selectively position one of the first side or the second side as the top of the frame.

17. The cart of claim 16, wherein the first post includes a first protrusion and a second protrusion, the first shelf coupled with the first protrusion, and the second shelf coupled with the second protrusion.

18. The cart of claim 14, the cart further comprising:
an accessory device including a plurality of prongs, the plurality of prongs configured to removably engage with at least two slots of the plurality of slots to couple the accessory device with the panel.

19. A cart, comprising:
a frame comprising:
a first post defining a first slot, the first slot having a bottom edge;
a second post defining a second slot, the second slot having a bottom edge;
a first shelf defining a top of the frame, the first shelf coupled to the first post and the second post;
a second shelf defining a bottom of the frame, the second shelf coupled to the first post and the second post; and
a third shelf positioned vertically between the first shelf and the second shelf, the third shelf coupled to the first post and the second post; and
a panel including a first prong, a second prong, and a plurality of slots, the first prong and the second prong having a first portion and a second portion, the first portion extending from a rear of the panel, the second portion extending from the first portion at angle relative to the first portion to define a notch between the rear of the panel and the second portion,
wherein the bottom edge of the first slot is engaged with the notch of the first prong to couple the panel with the first post;
wherein the bottom edge of the second slot is engaged with the notch of the second prong to couple the panel with the second post.

20. The cart of claim 19, wherein the first post includes a first protrusion, a second protrusion, and a third protrusion, wherein the first shelf is coupled with the first protrusion, the second shelf coupled with the second protrusion, and the third shelf is coupled with the third protrusion.
